(19) United States
(12) Patent Application Publication
(10) Pub. No.: US 2025/0375778 A1
(43) Pub. Date: Dec. 11, 2025

(54) MULTIFUNCTIONAL SHOWER

(71) Applicants: Mingqiang YAN, Fujian (CN); Shifa HUANG, Fujian (CN); Guozhong WU, Fujian (CN)

(72) Inventors: Mingqiang YAN, Fujian (CN); Shifa HUANG, Fujian (CN); Guozhong WU, Fujian (CN)

(21) Appl. No.: 18/889,429

(22) Filed: Sep. 19, 2024

(30) Foreign Application Priority Data
Jun. 11, 2024 (CN) 2024213129452

(51) Int. Cl. B05B 1/18; B05B 1/16

(52) U.S. Cl. CPC B05B 1/18; B05B 1/1636

(57) ABSTRACT

A multifunctional shower, having a shower body, a waterway switching apparatus, a flow regulating apparatus, and a control member; the waterway switching apparatus and the flow regulating apparatus are mounted on the shower body, and a water outlet end of the flow regulating apparatus is communicated with a water inlet end of the water flow switching apparatus; the control member is fitted in the shower body and is axially movable within the shower body; a waterway switching drive portion and a flow regulating drive portion are formed at two ends of the control member respectively; the waterway switching drive portion is capable of triggering the waterway switching apparatus, and the flow regulating drive portion is capable of triggering the flow regulating apparatus. Therefore, waterway switching and flow amount regulating functions can be achieved by only one control member to facilitate user's convenient operation.

### BACKGROUND OF THE INVENTION

The present invention relates to the field of showers, and in particular to a multifunctional shower.

Most of the existing showers are generally provided with only a waterway switching function which cannot simultaneously meet user's requirements for quick adjustment of an amount of water flow. Therefore, some of the existing showers are provided with both waterway switching function and flow amount regulating function, but this kind of dual-function showers are usually disposed with two control switches, where one of the control switches is used for waterway switching function, and another one of the control switches is used for flow amount regulating function. However, the use of two control switches to control the two different functions respectively is operatively inconvenient and structurally complicated.

In view of the above problems, there is a need for a multifunctional shower, which can control the waterway switching function and the flow amount regulating function by only one control member, thereby facilitating users to operate.

### BRIEF SUMMARY OF THE INVENTION

It is an object of the present invention to provide a multifunctional shower, which can control the waterway switching function and the flow amount regulating function by only one control member, thereby facilitating users to operate.

To attain the above object, the present invention provides the following technical solutions:

A multifunctional shower, comprising a shower body, a waterway switching apparatus, a flow regulating apparatus, and a control member; the waterway switching apparatus and the flow regulating apparatus are mounted on the shower body, and a water outlet end of the flow regulating apparatus is communicated with a water inlet end of the water flow switching apparatus; the control member is fitted in the shower body and is axially movable within the shower body; a waterway switching drive portion and a flow regulating drive portion are formed at two ends of the control member respectively; the waterway switching drive portion is capable of triggering the waterway switching apparatus, and the flow regulating drive portion is capable of triggering the flow regulating apparatus.

The waterway switching apparatus is provided with a translatable switching driving unit and a switching reset member that drives the switching driving unit to reset; the waterway switching drive portion of the control member is capable of pushing against the switching driving unit.

The waterway switching apparatus comprises a switching body, a water divider disc, a ratchet wheel, a pawl, the switching driving unit, and the switching reset member; the switching body is provided with a water divider cavity, at least two water outlet cavities selectively in communication with the water divider cavity through rotation of the water divider disc, and a water inlet port in communication with the water divider cavity; the water inlet port is in communication with the water outlet end of the flow regulating apparatus; the water divider disc is rotatably fitted in the water divider cavity, and the water divider disc is provided with at least two water divider ports each being capable to be in communication with a water inlet of a corresponding water outlet cavity; the ratchet wheel is rotatably fitted on an outer side of the switching body, and the ratchet wheel is coaxially connected to the water divider disc; the pawl is also disposed on the outer side of the switching body, and is elastically clutched with the ratchet wheel such that the ratchet wheel is rotatable only in one direction; the switching driving unit is translationally fitted on the outer side of the switching body, and the switching driving unit is provided with a push component which is capable of pushing against a respective ratchet tooth of the ratchet wheel; the switching reset member is fitted on the outer side of the switching body, and two ends of the switching reset member abut against the switching body and the switching driving unit respectively.

The switching driving unit is provided with a lateral sliding groove; the push component comprises a push block and a spring; the push block is slidably connected to the lateral sliding groove; one end of the push block abuts against the respective ratchet tooth of the ratchet wheel; the spring is accommodated in the lateral sliding groove; two ends of the spring abut against an inner side wall of the lateral sliding groove and the push block respectively.

The switching driving unit is provided with a driving rod, and the waterway switching drive portion of the control member is provided with a limiting notch slidably connected to the driving rod.

The flow regulating apparatus is provided with at least one regulating driving unit which is rotatable, and each regulating driving unit is provided with a lever; the flow regulating drive portion of the control member is capable of pushing or pulling the lever of each regulating driving unit.

The flow regulating drive portion of the control member is provided with at least one push-pull part corresponding to the lever of said at least one regulating driving unit; each push-pull part comprises a push block and a pull block spaced apart from each other; the push block and the pull block are capable of pushing against two opposite sides of the lever of a corresponding regulating driving unit respectively towards two opposite directions respectively.

The flow regulating apparatus comprises a flow regulating seat, a flow regulating valve core, and said at least one regulating driving unit; the flow regulating seat is provided with a water inlet channel, a water outlet channel, and a flow regulating cavity which is positioned between the water inlet channel and the water outlet channel and is in communication with the water inlet channel and the water outlet channel; the water outlet channel is in communication with the water inlet end of the water flow switching apparatus; the flow regulating valve core is rotatably fitted in the flow regulating cavity; the flow regulating valve core is rotatable in the flow regulating cavity to control a communication state between the water inlet channel and the water outlet channel; said at least one regulating driving unit is connected to the flow regulating valve core, and the lever of each regulating driving unit is located outside the flow regulating seat.

The flow regulating valve core is sealed against an inner wall of the flow regulating cavity; the flow regulating valve core is provided with a regulating channel capable to be in communication with the water inlet channel and the water outlet channel.

The waterway switching apparatus, the flow regulating apparatus, and the control member are integrated in the shower body; the shower body is provided with a water outlet limiting opening, a water inlet limiting opening, and a control limiting opening respectively to correspond to the waterway switching apparatus, the flow regulating apparatus, and the control member respectively; the control limiting opening is an elongated opening; the control member is connected to a control key; the control key is slidably connected to the control limiting opening.

According to the above technical solutions, the waterway switching apparatus and the flow regulating apparatus are used for realizing the functions of waterway switching and flow amount regulation respectively; by moving the control member axially within the shower body, the waterway switching drive portion of the control member can be brought to the waterway switching apparatus to operate the waterway switching apparatus, and the flow regulating drive portion of the control member can be brought to the flow regulating apparatus to operate the flow regulating apparatus, such that the waterway switching apparatus and the flow regulating apparatus can be controlled by axial translation of the control member within the shower body. Hence, the waterway switching function and the flow amount regulating function can be controlled by only one control member, thereby facilitating users to operate.

### BRIEF DESCRIPTION OF THE DRAWINGS

FIG. 1 is an exploded view of the present invention.

FIG. 2 is a schematic structural diagram of the present invention.

FIG. 3 is a first partial schematic structural diagram of the present invention.

FIG. 4 is a second partial schematic structural diagram of the present invention.

FIG. 5 is a third partial schematic structural diagram of the present invention.

FIG. 6 is a schematic structural diagram of a waterway switching apparatus of the present invention.

FIG. 7 is an exploded view of a waterway switching apparatus of the present invention.

FIG. 8 is a schematic structural diagram of a flow regulating apparatus of the present invention.

FIG. 9 is an exploded view of a flow regulating apparatus of the present invention.

FIG. 10 is a schematic structural diagram of a control member of the present invention.

FIG. 11 is a first cross-sectional view of the present invention.

FIG. 12 is a second cross-sectional view of the present invention.

FIG. 13 is a third cross-sectional view of the present invention.

### DESCRIPTION OF REFERENCE NUMERALS

a shower body 1, a water outlet limiting opening 11, a water inlet limiting opening 12, a control limiting opening 13,
a waterway switching apparatus 2, a switching body 21, a water inlet seat 2101, a water divider seat 2102, a water outlet panel 2103, a water divider cavity 211, a water outlet cavity 212, a water inlet port 213, a water divider disc 22, a water divider port 221, a ratchet wheel 23, a pawl 24, a switching driving unit 25, a lateral sliding groove 251, a driving rod 252, a switching reset member 26, a push component 27, a push block 271, a spring 272,
a flow regulating apparatus 3, a flow regulating seat 31, a water inlet channel 311, a water outlet channel 312, a flow regulating cavity 313, a flow regulating valve core 32, a regulating channel 321, a regulating driving unit 33, a lever 31,
a control member 4, a waterway switching drive portion 41, a limiting notch 411, a flow regulating drive portion 42, a push-pull part 421, a push block 4211, a pull block 4212,
and a control key 5.

### DETAILED DESCRIPTION OF THE INVENTION

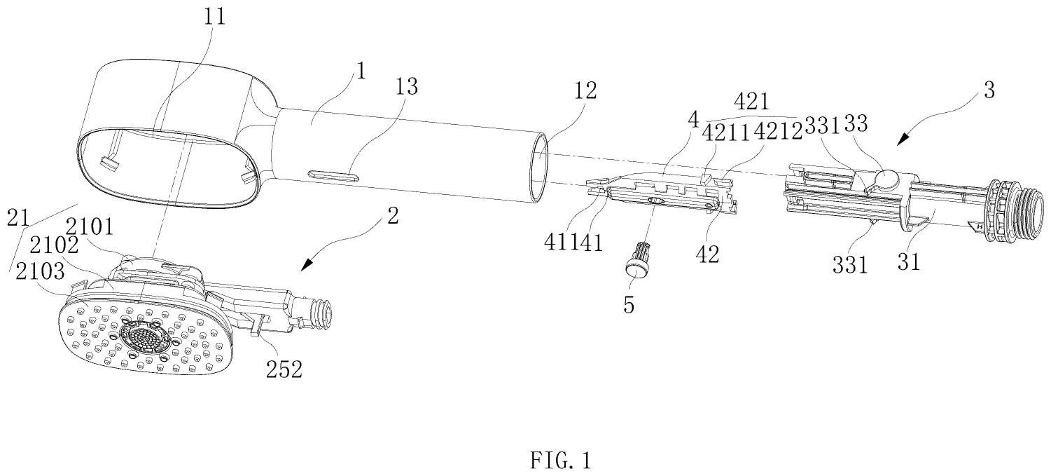

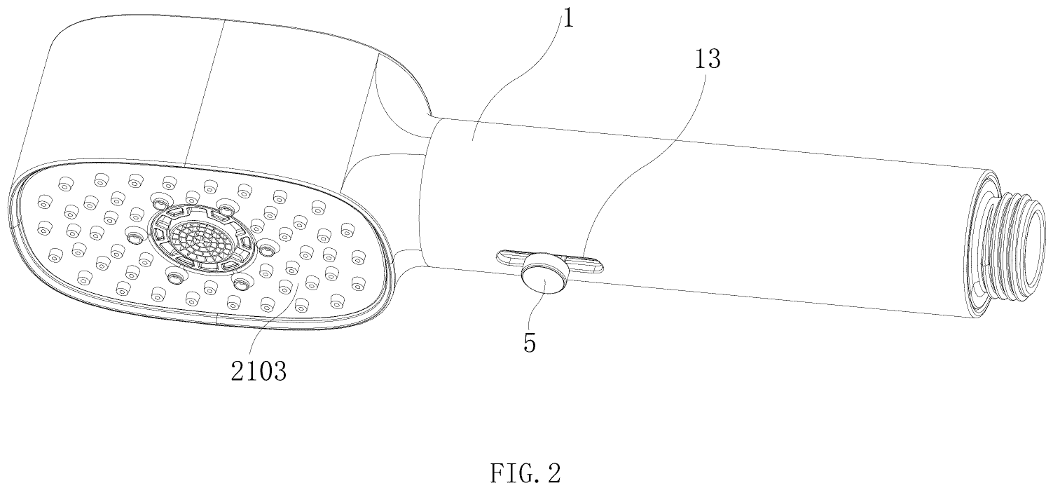

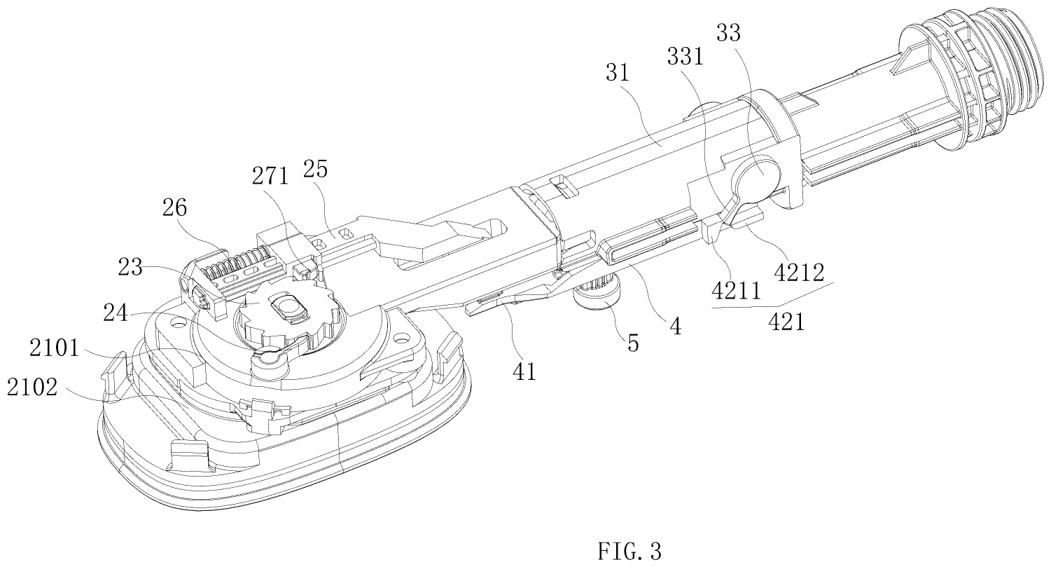

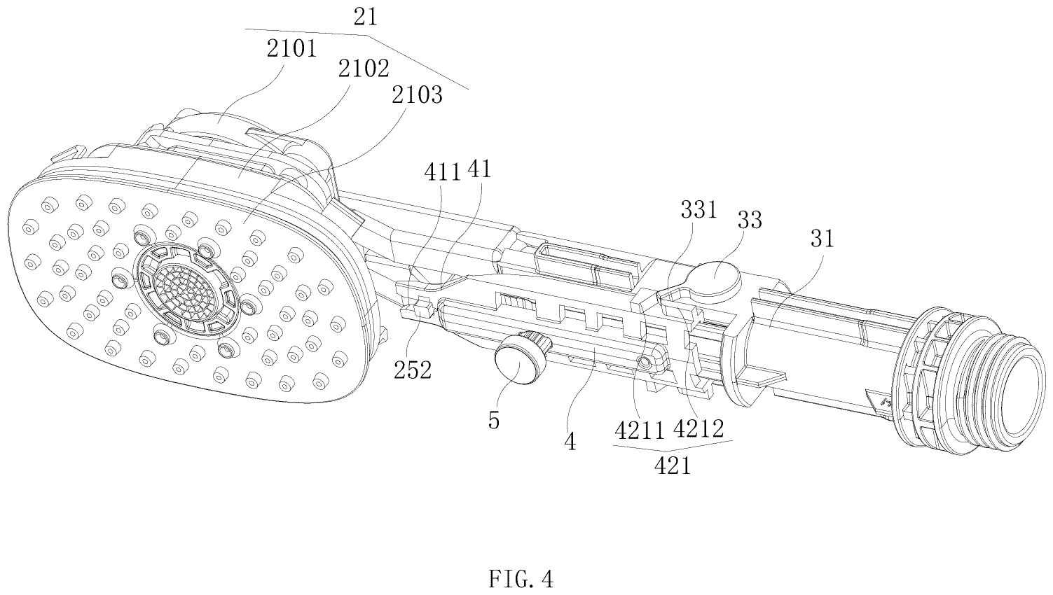

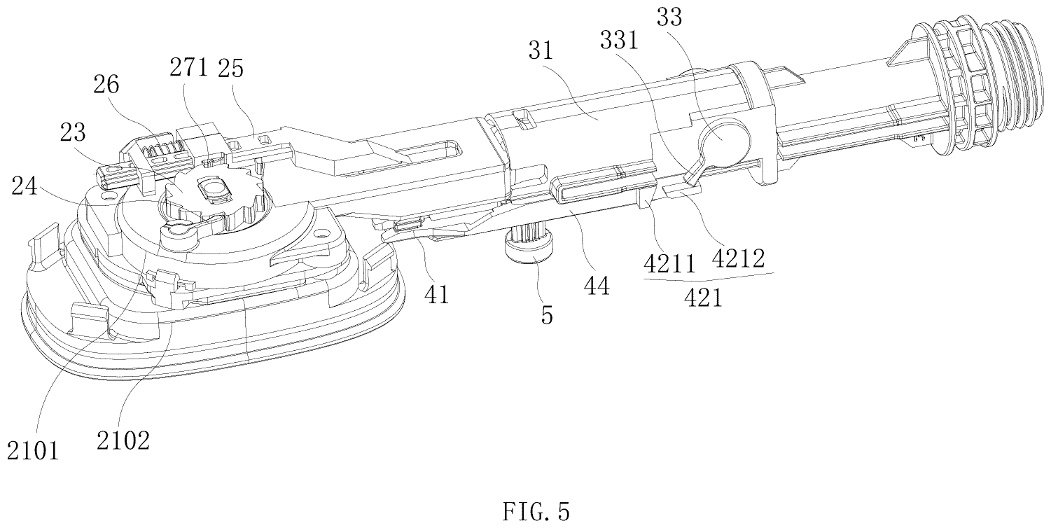

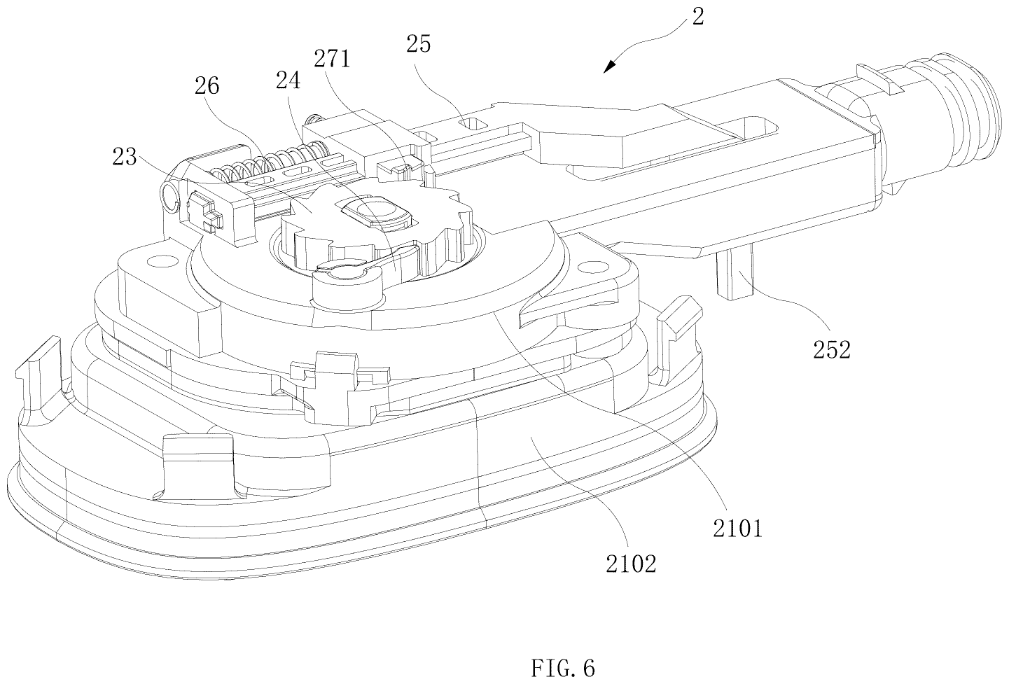

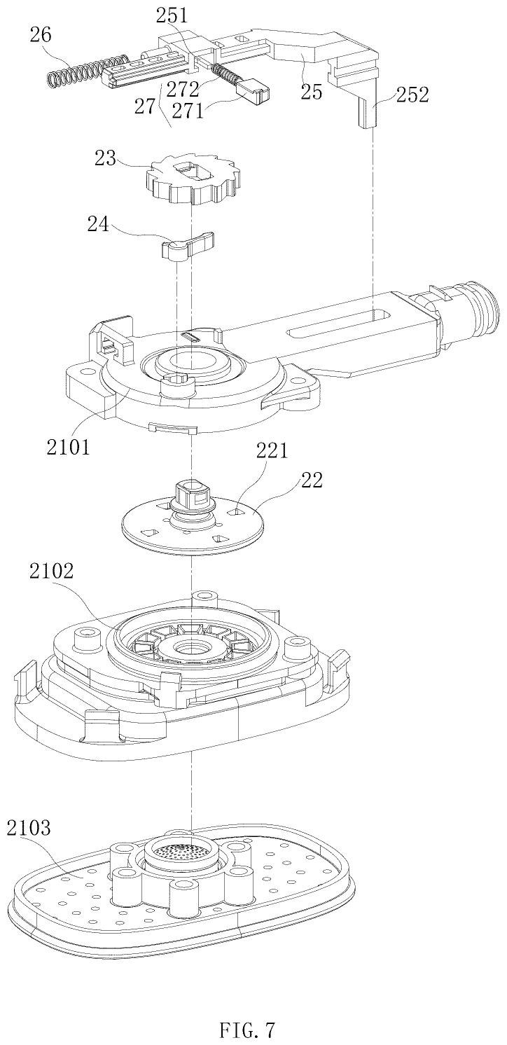

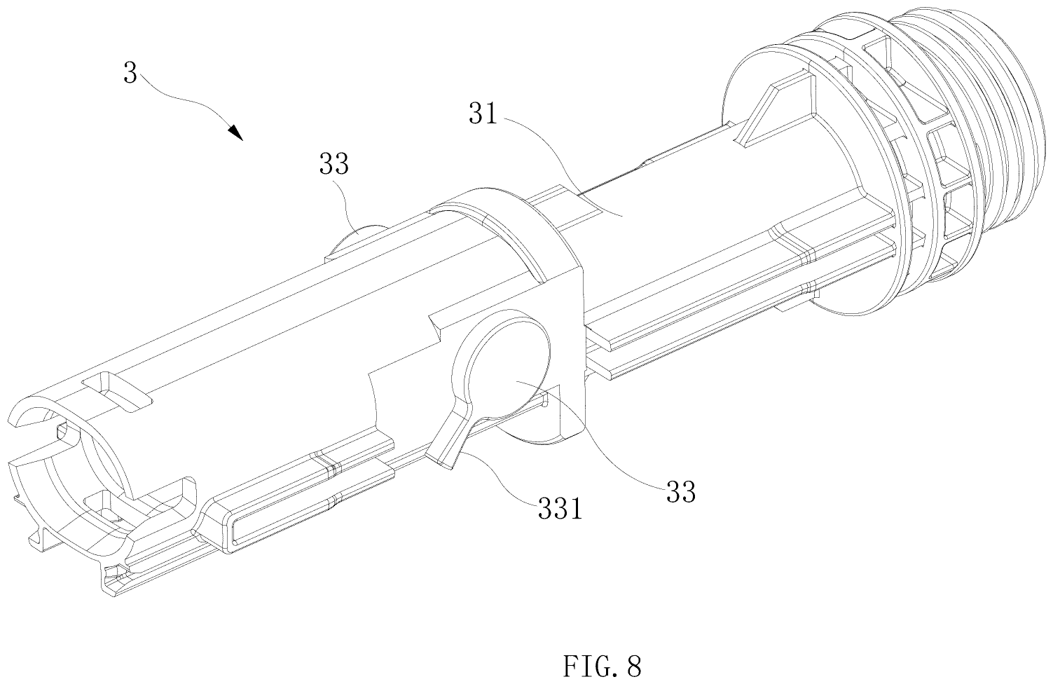

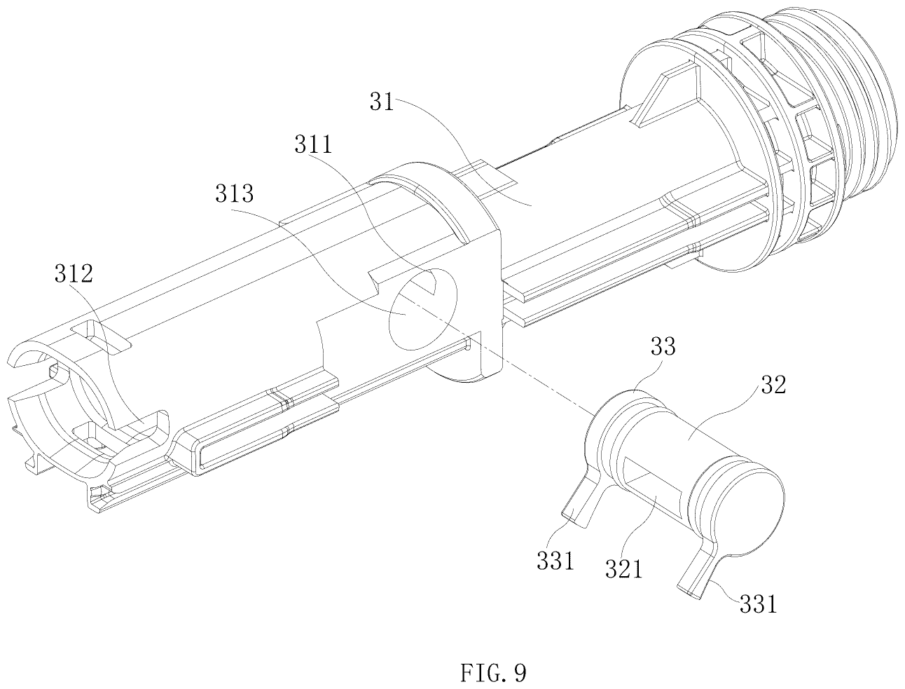

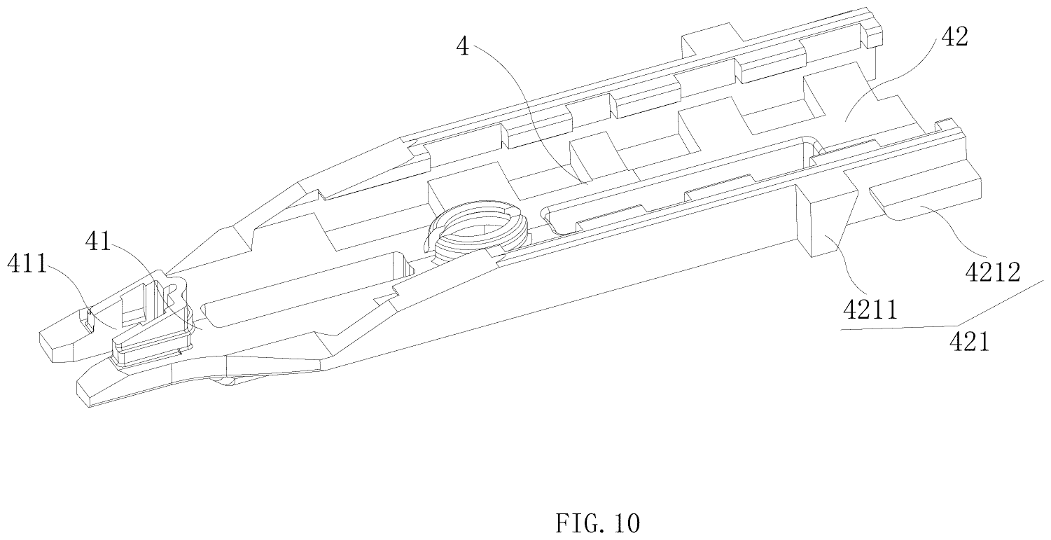

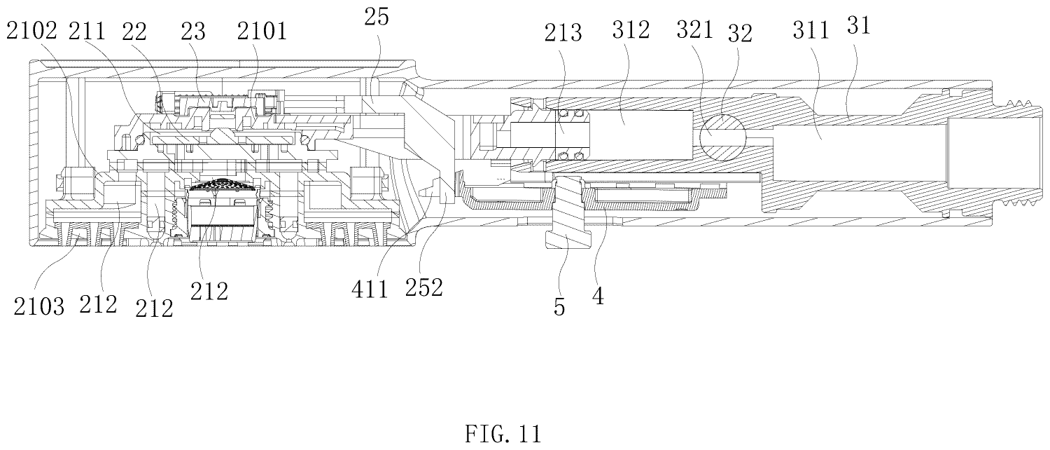

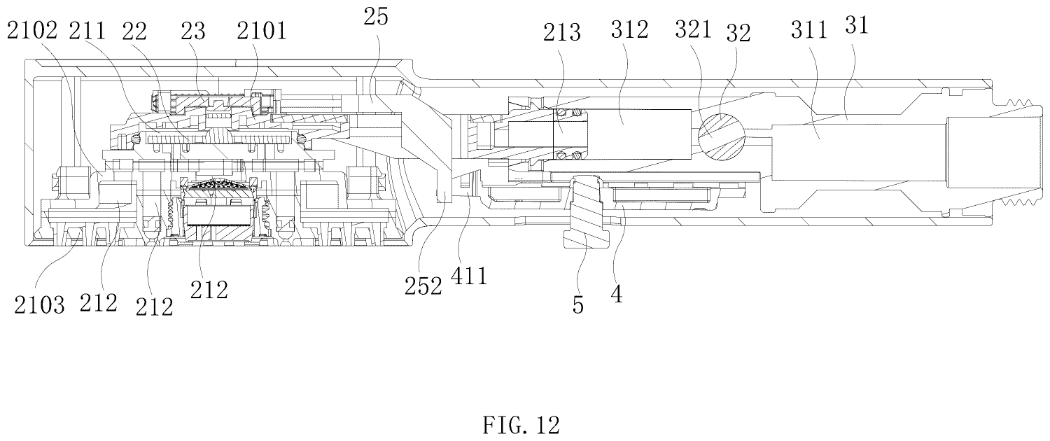

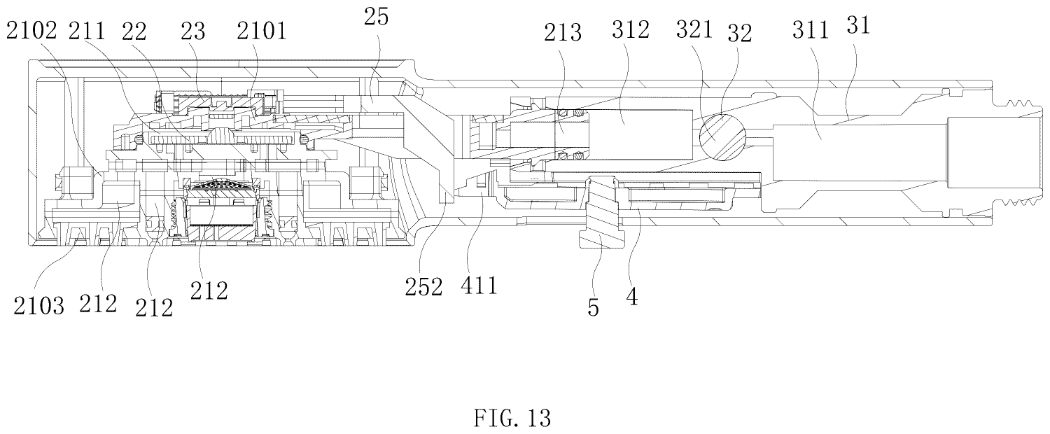

To further explain the technical solutions of the present invention, a detailed description of the present invention is provided below through specific embodiments. As shown in FIG. 1 to FIG. 13, the present invention discloses a

multifunctional shower, which comprises a shower body 1, a waterway switching apparatus 2, a flow regulating apparatus 3, and a control member 4; the waterway switching apparatus 2 and the flow regulating apparatus 3 are mounted on the shower body 1, and a water outlet end of the flow regulating apparatus 3 is communicated with a water inlet end of the water flow switching apparatus 2. The control member 4 is fitted in the shower body 1 and is axially movable within the shower body 1; a waterway switching drive portion 41 and a flow regulating drive portion 42 are formed at two ends of the control member 4 respectively; the waterway switching drive portion 41 is capable of triggering the waterway switching apparatus 2, and the flow regulating drive portion 42 is capable of triggering the flow regulating apparatus 3.

In the present invention, the waterway switching apparatus 2 and the flow regulating apparatus 3 are used for realizing the functions of waterway switching and flow amount regulation respectively; by moving the control member 4 axially within the shower body 1, the waterway switching drive portion 41 of the control member 4 can be brought to the waterway switching apparatus 2 to operate the waterway switching apparatus 2, and the flow regulating drive portion 42 of the control member 4 can be brought to the flow regulating apparatus 3 to operate the flow regulating apparatus 3, such that the waterway switching apparatus 2 and the flow regulating apparatus 3 can be controlled by axial translation of the control member 4 within the shower body. Hence, the waterway switching function and the flow amount regulating function can be controlled by only one control member 4, thereby facilitating users to operate.

In an embodiment of the present invention, the waterway switching apparatus 2 is provided with a translatable switching driving unit 25 and a switching reset member 26 that drives the switching driving unit 25 to reset; the waterway switching drive portion 41 of the control member 4 is capable of pushing against the switching driving unit 25 to drive the waterway switching apparatus 2 to switch waterway. The flow regulating apparatus 3 is provided with at least one regulating driving unit 33 which is rotatable, and each regulating driving unit 33 is provided with a lever 331. The flow regulating drive portion 42 of the control member 4 is capable of pushing or pulling the lever 331 of each regulating driving unit 33 to drive the flow regulating apparatus 3 to regulate an amount of water flow.

In an embodiment of the present invention, the waterway switching apparatus 2 comprises a switching body 21, a water divider disc 22, a ratchet wheel 23, a pawl 24, the switching driving unit 25, and the switching reset member 26. The switching body 21 is provided with a water divider cavity 211, at least two water outlet cavities 212 selectively in communication with the water divider cavity 211 through rotation of the water divider disc 22, and a water inlet port 213 in communication with the water divider cavity 211; the water inlet port 213 is in communication with the water outlet end of the flow regulating apparatus 3. The water divider disc 22 is rotatably fitted in the water divider cavity 211, and the water divider disc 22 is provided with at least two water divider ports 221 each being capable to be in communication with a water inlet of a corresponding water outlet cavity 212. The ratchet wheel 23 is rotatably fitted on an outer side of the switching body 21, and the ratchet wheel 23 is coaxially connected to the water divider disc 22. The pawl 24 is also disposed on the outer side of the switching body 21, and is elastically clutched with the ratchet wheel 23 such that the ratchet wheel 23 can only rotate in one direction. The switching driving unit 25 is translationally fitted on the outer side of the switching body 21, and the switching driving unit 25 is provided with a push component 27 which is capable of pushing against a ratchet tooth of the ratchet wheel 23. The switching reset member 26 is fitted on the outer side of the switching body 21, and two ends of the switching reset member 26 abut against the switching body 21 and the switching driving unit 25 respectively. When the control member 4 moves axially within the shower body 1 towards a first direction such that the waterway switching drive portion 41 of the control member 4 abuts against the switching driving unit 25, continued axial movement of the control member 4 towards the first direction will push the switching driving unit 25 to translate, which will compress the switching reset member 26 and also push the ratchet wheel 23 to rotate through the push component 27; rotation of the ratchet wheel 23 will then simultaneously drive the water divider disc 22 to rotate to switch waterway. When the control member 4 moves axially reversely towards a second direction opposite to the first direction such that the waterway switching drive portion 41 of the control member 4 moves away from and does not abut against the switching driving unit 25, the switching driving unit 25 is reset by the switching reset member 26, and the ratchet wheel 23 remains still due to the effect of the pawl 24, such that the water divider disc 22 remains in the currently rotated state.

In an embodiment of the present invention, the switching body 21 comprises a water inlet seat 2101, a water divider seat 2102, and a water outlet panel 2103 connected in sequence, where the water divider cavity 211 is formed between the water inlet seat 2101 and the water divider seat 2102, and said at least two water outlet cavities 212 are formed between the water divider seat 2102 and the water outlet panel 2103; the water inlet seat 2101 is provided with the water inlet port 213. The switching reset member 26 is a spring, and two ends of the switching reset member 26 are being inserted by the switching driving unit 25 and the switching body 21 respectively to prevent the switching reset member 26 from falling off. The switching driving unit 25 is provided with a lateral sliding groove 251. The push component 27 comprises a push block 271 and a spring 272, the push block 271 is slidably connected to the lateral sliding groove 251; one end of the push block 271 abuts against a ratchet tooth of the ratchet wheel 23; the spring 272 is accommodated in the lateral sliding groove 251; two ends of the spring 272 abut against an inner side wall of the lateral sliding groove 251 and the push block 271 respectively; the spring 272 ensures that the push block 271 stably abuts against the ratchet wheel 23. The switching driving unit 25 is provided with a driving rod 252, and the waterway switching drive portion 41 of the control member 4 is provided with a limiting notch 411 slidably connected to the driving rod 252, such that the waterway switching drive portion 41 of the control member 4 can push the switching driving unit 25 to translate more stably.

In an embodiment of the present invention, the flow regulating apparatus 3 comprises a flow regulating seat 31, a flow regulating valve core 32, and said at least one regulating driving unit 33. The flow regulating seat 31 is provided with a water inlet channel 311, a water outlet channel 312, and a flow regulating cavity 313 which is positioned between the water inlet channel 311 and the water outlet channel 312 and is in communication with the water inlet channel 311 and the water outlet channel 312; the water outlet channel 312 is in communication with the water inlet end of the water flow switching apparatus 2. The flow regulating valve core 32 is rotatably fitted in the flow regulating cavity 313; the flow regulating valve core 32 is rotatable in the flow regulating cavity 313 to control a communication state between the water inlet channel 311 and the water outlet channel 312. Said at least one regulating driving unit 33 is connected to the flow regulating valve core 32, and the lever 331 of each regulating driving unit 33 is located outside the flow regulating seat 31. When the control member 4 moves axially to allow the flow regulating drive portion 42 of the control member 4 to push or pull the lever 331 of said at least one regulating driving unit 33, said at least one regulating driving unit 33 will drive the flow regulating valve core 32 to rotate, so as to regulate the communication state between the water inlet channel 311 and the water outlet channel 312, thereby realizing flow amount regulation.

In an embodiment of the present invention, the flow regulating valve core 32 is sealed against an inner wall of the flow regulating cavity 313; the flow regulating valve core 32 is provided with a regulating channel 321 capable to be in communication with the water inlet channel 311 and the water outlet channel 312. When the flow regulating valve core 32 rotates, a degree of communication of the flow regulating valve core 32 with the water inlet channel 311 and the water outlet channel 312 will change correspondingly, such that the communication state between the water inlet channel 311 and the water outlet channel 312 is regulated to realize flow amount regulation. Said at least one regulating driving unit 33 may comprise two regulating driving units 33; the two regulating driving units 33 are connected to two ends of the flow regulating valve core 32 respectively, and the flow regulating drive portion 42 of the control member 4 is capable of pushing or pulling the lever 331 of each of these two regulating driving units 33, such that the flow regulating valve core 32 can rotate more smoothly. In case of said two regulating driving units 33, one of the two regulating driving units 33 is connected to the flow regulating valve core 32 after being formed independently, and another one of the two regulating driving units 33 is formed integrally with the flow regulating valve core 32 so as to simplify the assembling procedure. The flow regulating drive portion 42 of the control member 4 is provided with at least one push-pull part 421 corresponding to the lever 331 of said at least one regulating driving unit 33; each push-pull part 421 comprises a push block 4211 and a pull block 4212 spaced apart from each other; the push block 4211 and the pull block 4212 are capable of pushing against two opposite sides of the lever 331 of a corresponding regulating driving unit 33 respectively towards two opposite directions respectively, such that the flow regulating drive portion 42 can push or pull the lever 331.

In an embodiment of the present invention, the waterway switching apparatus 2, the flow regulating apparatus 3, and the control member 4 are integrated in the shower body 1. The shower body 1 is provided with a water outlet limiting opening 11, a water inlet limiting opening 12, and a control limiting opening 13 respectively to correspond to the waterway switching apparatus 2, the flow regulating apparatus 3, and the control member 4 respectively. The control limiting opening 13 is an elongated opening; the control member 4 is connected to a control key 5; the control key 5 is slidably connected to the control limiting opening 13; a user drives the control member 4 to move axially by driving the control key 5 to move; the control key 5 is provided to facilitate better operation of the control member 4 by the user.

The above embodiments and illustrations are not intended to limit the form and style of the product of the present invention. Any appropriate variations or modifications made by those of ordinary skills in the art within the scope of the present invention shall be considered as falling within the scope of the present invention.

What is claimed is:

1. A multifunctional shower, comprising a shower body, a waterway switching apparatus, a flow regulating apparatus, and a control member;
the waterway switching apparatus and the flow regulating apparatus are mounted on the shower body, and a water outlet end of the flow regulating apparatus is communicated with a water inlet end of the water flow switching apparatus;
the control member is fitted in the shower body and is axially movable within the shower body; a waterway switching drive portion and a flow regulating drive portion are formed at two ends of the control member respectively; the waterway switching drive portion is capable of triggering the waterway switching apparatus, and the flow regulating drive portion is capable of triggering the flow regulating apparatus.

2. The multifunctional shower of claim 1, wherein the waterway switching apparatus is provided with a translatable switching driving unit and a switching reset member that drives the switching driving unit to reset;
the waterway switching drive portion of the control member is capable of pushing against the switching driving unit.

3. The multifunctional shower of claim 2, wherein the waterway switching apparatus comprises a switching body, a water divider disc, a ratchet wheel, a pawl, the switching driving unit, and the switching reset member;
the switching body is provided with a water divider cavity, at least two water outlet cavities selectively in communication with the water divider cavity through rotation of the water divider disc, and a water inlet port in communication with the water divider cavity; the water inlet port is in communication with the water outlet end of the flow regulating apparatus;
the water divider disc is rotatably fitted in the water divider cavity, and the water divider disc is provided with at least two water divider ports each being capable to be in communication with a water inlet of a corresponding water outlet cavity;
the ratchet wheel is rotatably fitted on an outer side of the switching body, and the ratchet wheel is coaxially connected to the water divider disc;
the pawl is also disposed on the outer side of the switching body, and is elastically clutched with the ratchet wheel such that the ratchet wheel is rotatable only in one direction;
the switching driving unit is translationally fitted on the outer side of the switching body, and the switching driving unit is provided with a push component which is capable of pushing against a respective ratchet tooth of the ratchet wheel;
the switching reset member is fitted on the outer side of the switching body, and two ends of the switching reset member abut against the switching body and the switching driving unit respectively.

4. The multifunctional shower of claim 3, wherein the switching driving unit is provided with a lateral sliding groove;
the push component comprises a push block and a spring; the push block is slidably connected to the lateral sliding groove; one end of the push block abuts against the respective ratchet tooth of the ratchet wheel; the spring is accommodated in the lateral sliding groove; two ends of the spring abut against an inner side wall of the lateral sliding groove and the push block respectively.

5. The multifunctional shower of claim 2, wherein the switching driving unit is provided with a driving rod, and the waterway switching drive portion of the control member is provided with a limiting notch slidably connected to the driving rod.

6. The multifunctional shower of claim 1, wherein the flow regulating apparatus is provided with at least one regulating driving unit which is rotatable, and each regulating driving unit is provided with a lever; the flow regulating drive portion of the control member is capable of pushing or pulling the lever of each regulating driving unit.

7. The multifunctional shower of claim 6, wherein the flow regulating drive portion of the control member is provided with at least one push-pull part corresponding to the lever of said at least one regulating driving unit; each push-pull part comprises a push block and a pull block spaced apart from each other; the push block and the pull block are capable of pushing against two opposite sides of the lever of a corresponding regulating driving unit respectively towards two opposite directions respectively.

8. The multifunctional shower of claim 6, wherein the flow regulating apparatus comprises a flow regulating seat, a flow regulating valve core, and said at least one regulating driving unit;
the flow regulating seat is provided with a water inlet channel, a water outlet channel, and a flow regulating cavity which is positioned between the water inlet channel and the water outlet channel and is in communication with the water inlet channel and the water outlet channel; the water outlet channel is in communication with the water inlet end of the water flow switching apparatus;
the flow regulating valve core is rotatably fitted in the flow regulating cavity; the flow regulating valve core is rotatable in the flow regulating cavity to control a communication state between the water inlet channel and the water outlet channel;
said at least one regulating driving unit is connected to the flow regulating valve core, and the lever of each regulating driving unit is located outside the flow regulating seat.

9. The multifunctional shower of claim 8, wherein the flow regulating valve core is sealed against an inner wall of the flow regulating cavity; the flow regulating valve core is provided with a regulating channel capable to be in communication with the water inlet channel and the water outlet channel.

10. The multifunctional shower of claim 1, wherein the waterway switching apparatus, the flow regulating apparatus, and the control member are integrated in the shower body; the shower body is provided with a water outlet limiting opening, a water inlet limiting opening, and a control limiting opening respectively to correspond to the waterway switching apparatus, the flow regulating apparatus, and the control member respectively; the control limiting opening is an elongated opening; the control member is connected to a control key; the control key is slidably connected to the control limiting opening.
